(19) United States
(12) Patent Application Publication
(10) Pub. No.: US 2006/0061546 A1
(43) Pub. Date: Mar. 23, 2006

(54) Handbag/purse based combination electronic gadgets

(75) Inventor: Chiou-muh Jong, Ellicott City, MD (US)

Correspondence Address: CHIOU-MUH JONG, 11058 DORCH FARM ROAD, ELLICOTT CITY, MD, 21042, US

(73) Assignee: Chiou-muh Jong, Ellicott City, MD (US)

(21) Appl. No.: 11/160,485

(22) Filed: Jun. 27, 2005

Related U.S. Application Data
(60) Provisional application No. 60/522,382, filed on Sep. 22, 2004.

(51) Int. Cl. G09G 5/00

(52) U.S. Cl. 345/156

(57) ABSTRACT

In present invention, a way to combine the applications and convenience of several electronic devices into a handbag/purse while preserving the fashion is presented. The much bigger screen in present invention, as compared to those in devices such as personal digital assistant and cellular phone, is ideal for multiple uses such as DVD player, TV, VOIP telephone screen and more importantly, so ideal to display pictures that will make many picture printings unnecessary.

### 2. CROSS-REFERENCE INFORMATION

The present application claims the priority to co-pending U.S. Provision patent application Ser. No. 60/522382 entitled “Handbag/purse based combination electronic gadgets” filed on Sep. 22, 2004.

### 1. FIELD OF INVENTION

The present invention relates to embedding electronic hardware and functions such as image display, processor and memory storage into hand carrying bags such as handbag, school bag, purse, toolbox and briefcase.

### 3. BACKGROUND OF THE INVENTION

As technologies in electronic applications advance, many electronic devices such as laptop computer, cellular phone, DVD player, personal digital assistant (PDA) and digital camera etc. gradually enter our daily life as necessary items. While using each of them gives us convenience and comfort, carrying all of them around is still very awkward and annoying even with the advancing “wireless” technology frees us much trouble of the tangling of wires.

Some electronic gadgets, PDA for example, has small display screen because its nature of being hand carrying device constraints the product size and consequently limits the size of display screen. This size limitation in display imposes a severe design challenge in the representation of graphic content in its display screen, and the result usually causes either lack of good resolution or unable to display whole part of a graphic image and consequently the product is not as useful as the product is designed to be.

One solution to such problem is to integrate all the hardware and functions into some utility items most people are used to carrying in most of the time they move around. We know that most women carry handbags or purses everyday, a lot of men carry briefcases to work or traveling and most students carry book bags. Most of these items have an outside shell which can provide a relatively flat surface of more than 4″×6″, an area much bigger than the screens in cellular phones or PDA's. This area can be used to install a light weighted display screen such as LCD (liquid crystal display), which can serve as a screen for DVD player, PDA and even small computer comparable to a laptop. It can also serve as a display for picture files or as a display for digital books.

The central theme for using hand carrying bags or purses is that these items are always with the owners or close to them within a voice-reachable distance and can provide a big enough surface area for installing a light weight LCD, OLED (organic light emitting display) or other light-weighted monitors for various display purposes. Furthermore, the bottom part and layers in-between outer shells of the bags/purses provide plenty of space to install electronic hardware modules such as mother board, data bus and data storage device and consequently the distributed layout makes the cooling of these devices an much easier task to design.

Another way to describe present invention is that the new layout of combination of various electronic gadgets makes it possible to be also used as a fashion hand carrying bag/purse and thus neatly integrates the daily convenience into one item.

With more and more affordable electronic technologies, hand carrying handbag/purse installed with display screen and other electronic hardware can be within reasonable price, which may still be lower than high end prices of those products, but it can provide some useful functions in our daily life such as taking and displaying pictures, viewing movie, playing music, browsing internet and so forth, without carrying so many items at same time. Even the convenience of using it solely as a backup machine for home computers, DVD players or viewing pictures alone will justify the usefulness of current invention.

Currently, some efforts have already tried to combine briefcase/handbag/purse and electronic gadgets such as computer, PDA together to take advantages of convenience, portability and fashion into a handy item. For example, U.S. Published No. 20040144665 proposed a handbag with space to house PDA and out-shell touch-screen to help manipulating the dialing operation of the PDA. U.S. Published No. 20040085718 shows portable workstation computer compacted in a briefcase. Other inventions such as U.S. Pat. Nos. 6,549,229, 6,442018, 6,257,407 and 5,967,270 use most of the space in the handbag/briefcase for housing electronic hardware and thus the sole inventions are for the portability and convenience of computer, not available for carrying other miscellaneous unrelated items. Also, while all the inventions mentioned above attempted to combine briefcase/handbag/purse and electronic gadgets, no attempts are shown to use out-shell surface as an area to install monitor for content display.

Recently, it has been a popular design to offer digital camera in the small cellular phones. However, the space limitation inside the cellular phone makes it difficult to install complicated camera. By contrast, the bags in the current invention can provide more room for installing professional like digital camera. There is also more room for installing the battery pack, which will apparently extend the hours of continuous usage of all the gadgets equipped in the bag between recharges of the batteries.

In addition to light weighted display monitors such as LCD, recent development in projector technologies makes light weighted, portable projector such as Digital Light Projector (DLP) as an excellent alternative to using display monitors. The DLP Model LP12 Ultra-Portable manufactured by InFocus for example, has a weight merely 1.98 lbs, small enough to be palm held size, can be easily installed into briefcase/handbag/toolbox and the likes for display purpose. In this case, a retractable small projector screen can be carried inside the handbag, or one can always use the white wall as a projector screen.

### 4. SUMMARY OF THE INVENTION

The combination electronic gadgets distributively installed in a hand carrying handbag/purse takes advantages of bigger surface area for installing display monitor, frees daily users of electronic gadgets from carrying them separately at the same time, the present invention combines daily carried fashion item with the conveniences of using a variety of electronic gadgets which are getting more popular and necessary in our daily life.

### 5. BRIEF DESCRIPTION OF THE DRAWINGS

FIG. 1 shows one embodiment of present invention. A handbag designed to equip with display screen mounting on the out-shell surface is used to illustrated the present invention. A wireless keyboard with bluetooth technology or soft keyboard pad can be equipped to provide easy input function.

### 6. DETAILED DESCRIPTION OF THE PRESENT INVENTION

The objective of present invention is to combine the fashion of a hand carrying handbag/purse and the likes with the functions of multi-gadgets such as PDA, camera, laptop, DVD etc. together while providing bigger screen display size, reserving carrying function of handbag and the likes, and freeing the users from carrying many items at the same time.

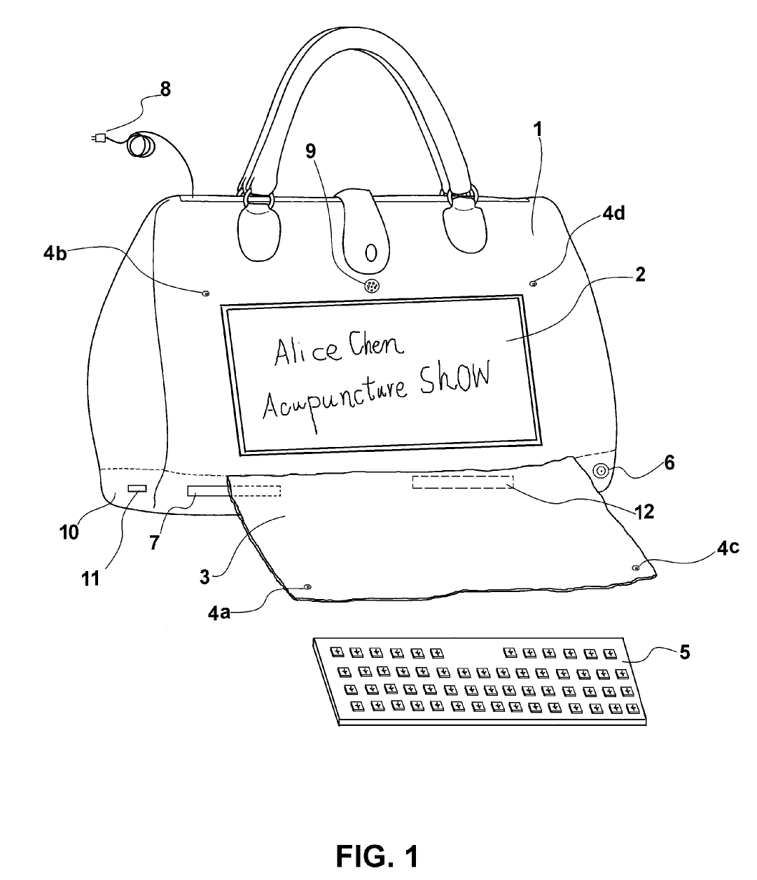

As one embodiment of present invention, FIG. 1 shows the handbag 1 with a surface area usually big enough to mount a display screen 2 of more than 7 inches in diagonal on its outer-shell. For protecting display screen 2, a soft cover 3 is fixed in one end to the handbag, while other end can be locked in protecting position by two pairs of buttons 4a with 4b and 4c with 4d. The soft cover 3 can be a functional soft keyboard pad, coated in outside layer with same material as that of the outer-shell of the handbag. If the soft cover 3 is solely used as a cover to protect display screen, then a separate wireless keyboard 5, which communicates with handbag gadgets by technology such as Bluetooth can be provided.

Typically, at least a room, bottom partition 10 of the handbag 1 for example, can be partitioned to house hardware mother board, CPU, memory, digital camera 6, DVD tray 12 and interface hardware such as multi-USB ports 7 and flash memory interface 11. While most hardware items are installed in or close to hardware partition, item such as microphone 9 is small and for purpose of spreading over the handbag, it can be installed on the top portion of the outer-shell surface and is connected to other hardware items by wire buried in-between layers of outer-shell.

Additionally, the bottom hardware partition 10 has also room for battery pack and any necessary power supply/converter/charger equipment. A power cord 8 connecting battery charger and outside AC power source can also be provided for convenience. Alternatively, fuel cell power source/battery pack can also be installed when commercial fuel cell battery is available on the market.

The maturity in manufacturing display monitor such as LCD and OLED will soon make it very cost effective to install a screen of size much bigger than those on the currently available cellular phones and PDA's. In addition, Personal computer technology is very mature too, thus combination of these two mature technologies make customizing different levels of functions with handbags very cost effective and easy to do. For example, one preferred embodiment of current invention will be handbag with LCD screen for DVD and PDA, plus digital camera functions such that any user carrying it can do simple computer work, play DVD for entertainment, takes photo with good resolution and shows them easily.

As mentioned earlier, the advancing development in projector technology makes DLP small, highly portable and thus is also suitable to be equipped in a handbag/toolbox as an alternative display device for LCD monitor. One preferred embodiment of current invention will be a rectangular toolbox installed with DLP for bigger display screen and even higher resolution and would apparently be a good choice for technicians who like to carry only one toolbox in which some gadgets such as computer, communication tool are also ready to use.

School bags implemented with different levels of computer applications according to current invention can be very useful for different grade students respectively. For lower grades such as 1, 2 and 3, the computer imbedded should be customized to be a simple, special purposed, but equipped with easy communication by wireless connection such as WiFi (Wireless Fidelity) with home computers or parents' laptops or other wireless communication gadgets. For high school students, on the other hand, the computer can function more like a regular market laptop or smaller version, equipped with VOIP (Voice over Internet Protocol) communication to free them from bringing additional cellular phone. Of course, other hardware and software special for education purpose can also be installed making school bag a customized education tool, yet still can carry real books, lunch and other items to school without worrying about losing cellular phone, computer, PDA etc., which more and more students carry to school.

With the integration of electronic gadgets and fashion handbag/briefcase and the likes according current invention, it is a combination of convenience and fashion. While present invention has been shown, described and illustrated in detail for illustration purpose, it should be understood by those skilled in the art that equivalent changes in form and detail may be made therein without departing from the true spirit and scope of the invention as disclosed in the accompanying claims.

What is claimed is:

1. A handbag based electronic device combination comprising:
a handbag with multiple pieces of outer-shells integrated as whole envelope of said handbag;
a surface area at least 3″×4″ in width by length or length by width on at least one piece of said outer-shells;
at least one hardware partitions inside said handbag;
electronic hardware housed in said hardware partitions; and
data bus and power cords hidden inside layers of said outer-shell and layers of partitions for shielding said data bus and said power cords from carried items in said handbag.

2. The handbag based electronic device combination according to claim 1, whereon the inside or outside of said surface area a display screen is mounted as an integral part of one piece of said outer-shells; or
a portable projector, preferably a portable digital light projector (DLP), is mounted vertically and outwardly on one piece of said outer-shells, as an integral part of said outer-shells for projecting display on a projector screen; or
a combination of said display screen and said portable projector are mounted as an integral part of said outer-shells.

3. The handbag based electronic device combination according to claim 1, wherein more than 50 percent of total expandable volume is available for carrying various items irrelevant to the electronic and software functions of said handbag based electronic device combination.

4. The handbag based electronic device combination according to claim 1, wherein said handbag includes, but not limited to handbag, briefcase, school bag, traveling bag, portable tool box and hand carrying purse.

5. The handbag based electronic device combination according to claim 1, wherein said electronic hardware comprises CPU, mother board, memory device, audio disk drive, video disk drive, digital camera, microphone, speaker and peripheral interfaces necessary to communicate with other devices or any combination thereof.

6. The handbag based electronic device combination according to claim 1 further comprising software coupling with said electronic hardware for performing functions of playing music, playing video images, playing movie, playing games, digital camera operation, television, digital personal assistant, wireless telephony, voice over internet protocol video telephony, personal computer or any combination thereof.

7. The handbag based electronic device combination according to claim 6, wherein said software further comprising programs to drive wired or wireless keyboard and mouse.

8. The handbag based electronic device combination according to claim 1, wherein hardware partitions further housing power source comprises rechargeable battery assembly or refuel able fuel cell battery assembly, or combination thereof.

9. The handbag based electronic device combination according to claim 2, wherein said display screen comprises flat panel monitors, which are thin and light weighted enough to be installed on said outer-shell surface.

10. The handbag based electronic device combination according to claim 2, wherein said projector screen includes flat wall surface and portable retractable screen.

11. A handbag based electronic gadget combination comprising:
a handbag with multiple pieces of outer-shells integrated as whole envelope of said handbag;
a surface area at least 3″×4″ in width by length or length by width on at least one piece of said outer-shells;
a display device installed as an integral part of said outer-shells;
at least one hardware partitions inside said handbag;
electronic hardware includes but not limited to CPU, mother board, memory device, video disk drive, peripheral interfaces, rechargeable battery assembly housed in said hardware partitions;
a digital camera mounted on one piece of said outer-shells as an integral part of said outer-shells;
at least one speaker mounted on one piece of said outer-shells as an integral part of said outer-shells;
a microphone mounted on one piece of said outer-shells as an integral part of said outer-shells for the input of voice signals; and
data bus and power cords hidden inside layers of said outer-shells and layers of partitions for shielding said data bus and said power cords from carried items in said handbag.

12. The handbag based electronic gadget combination according claim 11, wherein said display device is either a digital light projector or a flat panel display monitor, mounted on said outer-shell surface as an integral part of said outer-shell surface.

13. The handbag based electronic gadget combination according to claim 11, wherein said handbag includes, but not limited to handbag, briefcase, school bag, traveling bag, portable tool box and hand carrying purse.

14. A handbag based electronic apparatus combination comprising:
a handbag with multiple pieces of outer-shells integrated as whole envelope of said handbag;
a surface area at least 3″×4″ in width by length or length by width on at least one piece of said outer-shells;
a display device installed as an integral part of said outer-shells;
at least one hardware partition inside said handbag; electronic hardware includes but not limited to CPU, mother board, memory device, video disk drive, peripheral interfaces, rechargeable battery assembly housed in said hardware partitions; and data bus and power cords hidden inside layers of said outer-shell and layers of partitions for shielding said data bus and said power cords from carried items in said handbag.

15. The handbag based electronic apparatus combination according claim 14, wherein said display device is either a digital light projector or a flat panel display monitor, mounted on said outer-shell surface as an integral part of said outer-shell surface.

16. The handbag based electronic apparatus combination according to claim 14, wherein said handbag includes, but not limited to handbag, briefcase, school bag, traveling bag, portable tool box and hand carrying purse.
